(19) United States
(12) Patent Application Publication
(10) Pub. No.: US 2014/0165867 A1
(43) Pub. Date: Jun. 19, 2014

(54) Direct Inkjet Offset Lithographic Printing System

(71) Applicant: Recognition Systems, Inc., Port Washington, NY (US)

(72) Inventors: Dino Paro, Montcalieri-Torino (IT); Charles D. DeBoer, Ithaca, NY (US)

(73) Assignee: ecognition Systems, Inc., Port Washington, NY (US)

(21) Appl. No.: 13/910,545

(22) Filed: Jun. 5, 2013

Related U.S. Application Data
(60) Provisional application No. 61/656,955, filed on Jun. 7, 2012.

(51) Int. Cl. B41N 1/08

(52) U.S. Cl. CPC B41N 1/083
USPC 101/457; 205/50

(57) ABSTRACT

A method of producing an offset lithographic printing plate including the steps of providing a grained, anodized and passivated aluminum plate of preferred surface roughness; applying a receptive coating to the grained aluminum plate; image-wise applying an inkjet fluid on top of the receptive coating; and heating the oleophilic inkjet fluid allowing an oleophilic resin of the inkjet fluid to bond with the grained aluminum.

### RELATED APPLICATIONS

This application is a non-provisional application which replaces provisional application filed 7 Jun. 2012 under Ser. No. 61/656955 entitled Direct Inkjet Offset Lithographic Printing System, and claims the benefit of the provisional filing.

### TECHNICAL FIELD

Printing technology, more specifically, direct inkjet lithographic printing technology.

### BACKGROUND

Offset printing, also known as lithographic printing, is widely known for printing books and newspapers. In offset printing, the inked image is transferred (or “offset”) from a plate to a rubber blanket, and from there to the paper. The lithographic printing plate depends on the principle of the immiscibility of oil and water. When used in combination with offset printing, the technique employs a flat (planographic) image carrier on which the image to be printed obtains ink from ink rollers, while the non-printing area attracts a film of water, keeping the non-printing areas ink-free.

There have been previous attempts to apply “direct” inkjet printing techniques to lithographic printing. For example, European Patent Publication No. 503,621 discloses a direct lithographic plate making method which includes jetting a photocurable ink onto the plate substrate, and exposing the plate to UV radiation to harden the image area. An oil-based ink may then be transferred to the image area for printing onto a printing medium. However, the resolution of the ink droplets jetted onto the substrate is inadequate, and the durability of the lithographic printing plate with respect to printing run length is also undesirable. In addition, the extra step of exposing the plate to UV radiation is cumbersome.

U.S. Pat. No. 6,758,140 discloses a method for preparing lithographic printing plates including the steps of: (a) coating a substrate with a mixture including colloidal silica, fumed alumina, polyethylenimine, a quaternary ammonium polymer and a hardener; (b) utilizing an inkjet printer with pigmented inks to print a digital image on the coated substrate; and (c) drying the image. The problem with this is that the printing plate with a porous layer to accept the ink jet dots causes spreading of the inkjet fluid and lacks the high resolution and sharp edges needed for quality printing.

U.S. Pat. No. 6,245,421, discloses a printable media including: (a) a substrate having a hydrophilic, porous layer on at least one surface, the hydrophilic layer comprising a water soluble binder, a hardening agent and a clay; and (b) an ink receptive, thermoplastic image layer adhered to the hydrophilic porous layer, wherein the ink receptive layer contains a copolymer having a low surface energy and a plurality of tertiary amine sites, the amine sites being at least partially neutralized with an acid. The disadvantage of this method is by using the hydrophilic porous layer, the high resolution and sharp edges needed for quality printing are difficult to achieve.

U.S. Pat. No. 6,276,273 discloses a printing plate precursor for direct receipt of an image-wise applied ink receptive layer, comprising a desorbable surfactant adsorbed on at least one surface of a printing plate substrate, wherein the desorbable surfactant is present in an amount effective to improve the resolution of the subsequently image-wise applied ink receptive layer, and the desorbable surfactant is discontinuously adsorbed on said printing plate substrate. The patent discloses several aluminum printing plate substrates, with different kinds of graining, anodizing and passivation treatments. The patent is silent on the question of substrate smoothness, and does not indicate the quality of small reverse type fonts. The patent also teaches that a continuous surfactant layer would prevent bonding of the inkjet image to the aluminum surface. The main problem with this printing plate is that of commercial practicality. A discontinuous monolayer of surfactant will be difficult to manufacture, package, ship and store without damage to the fragile surfactant layer.

Also, it has been known to improve the resolution of inkjet printers by applying an ink receiving layer to substrates such as metal, plastic, rubber, fabrics, leather, glass and ceramics, prior to printing thereon. Some examples can be found in European Patent Publication No. 738,608 which discloses a thermally curable ink receiving layer containing a first water soluble high molecular weight compound having a cationic site in the main compound and having a side chain containing a condensable functional site. Alternatively, the second high molecular weight compound may be replaced with a monomer or oligomer having at least two (meth)acryloyl sites, which results in a UV radiation curable ink receiving layer. The extra step of UV radiation curing limits the utility of such a process.

Also, a chemical process is often used in the process for producing a lithographic printing plate. For example, U.S. Pat. No. 6,691,618 discloses a process for imaging a lithographic printing plate having a presensitizing coating, comprising the steps in sequence of: a) blanket exposing the coating; and b) image-wise applying droplets of an insolubilizing chemical in a solvent carrier to the coating. The multiple steps of the process are cumbersome and expensive.

Improving the resolution of printing plates made by the inkjet method has always been a challenge. A particular aspect of the challenge is to print thin white lines on a dark background. Despite numerous attempts to improve resolution, however, there continues to be a need for improved printing resolution, along with a wide tone scale, high Dmax, fast runup and wide operating latitude on the press, all by inkjet printing without chemical processing.

### SUMMARY

The problems described above are solved by an inkjet imageable lithographic printing plate precursor comprising a grained anodized aluminum support having a continuous overcoat of at least one water soluble polymer with at least one surfactant to provide a surface energy producing a contact angle greater than 100 degrees with a sessile drop of water and the overcoated surface is smoother than about 1 micron as measured by the arithmetic average of absolute values.

### FIGURES

FIG. 1 is an illustration of the grained anodized aluminum substrate of the embodiment.

FIG. 2 is an illustration of an overcoated receiving layer continuously disposed on the substrate.

FIG. 3 is an illustration of the inkjet fluid image dots printed on the overcoated substrate.

FIG. 4 is an illustration of the dried and baked plate, now ready for the printing.

FIG. 5 is an approximately 50X photomicrographic comparison of 70% tint dots on printing plates of different roughness values.

FIG. 6 is an approximately 50X photomicrographic comparison of 30% tint dots on printing plates of different roughness values.

FIG. 7 is an approximately 50X photomicrographic comparison of small reverse type on printing plates of different roughness values.

### DETAILED DESCRIPTION

We have found an improved method of producing a direct inkjet lithographic printing plate. The plate is imaged by inkjet printing, dried and cured by heating, and then mounted on the press without any further processing. Plates prepared by this method produce high quality impressions on the press, including clean, open reverse (white letters on dark background) letters of the smallest sizes.

For many years lithographic printing plates have predominantly been made with grained anodized aluminum surfaces, as is well known to those skilled in the art of printing. The roughness of the grained anodized aluminum can be controlled both by the graining method and the time and electrical current level of the anodizing process. A plate with a rougher surface carries more fountain solution on the press, which may allow the press operator more latitude in maintaining the ink/water balance when printing. On the other hand, a plate with a smoother surface may offer sharper edges in the printed impressions on a lithographic printing press. In this embodiment we have found that an optimized level of smoothness produces a higher quality image, particularly in small reverse type, that is, in uninked (white) letters on an inked background. In a preferred embodiment, the surface roughness is between 0.1 and 1 microns, being measured by an arithmetic average of absolute values measuring stylus, as is well known to those skilled in the art. In a more preferred embodiment, the roughness is between 0.2 and 0.75 microns, and in a most preferred embodiment the surface roughness is between about 0.2 and about 0.4 microns. The preferred surface roughness of the aluminum plate is bounded on both the lower and upper values. The limit on the low side of surface roughness is primarily determined by the performance of the printing press. If the surface roughness is too low, for example, if the surface is mirror smooth polished, the plate will not carry enough fountain solution on the printing press, and the press operator will have very narrow working latitude for the ink/water balance on the press. This results in an excessive number of unsalable impressions caused by scum in the background areas and/or blind spots in the image areas. On the high side of the surface roughness values, we have found that a rougher surface results in blocked shadow areas, that is, filled in small white dots in dark areas of the print, blocked (filled in) reverse type and filled in fine white lines on a dark printed background.

FIG. 5 shows photomicrographs of three grained anodized aluminum plates differing only in their surface roughness. The plates all have the same polymer overcoat, described in detail below. The plates have all been printed on the same inkjet printer with the same inkjet fluid with an identical pattern of 70% dots at a 150 lines per inch screen ruling. Photomicrographs of the dot pattern have been captured at the same magnification.

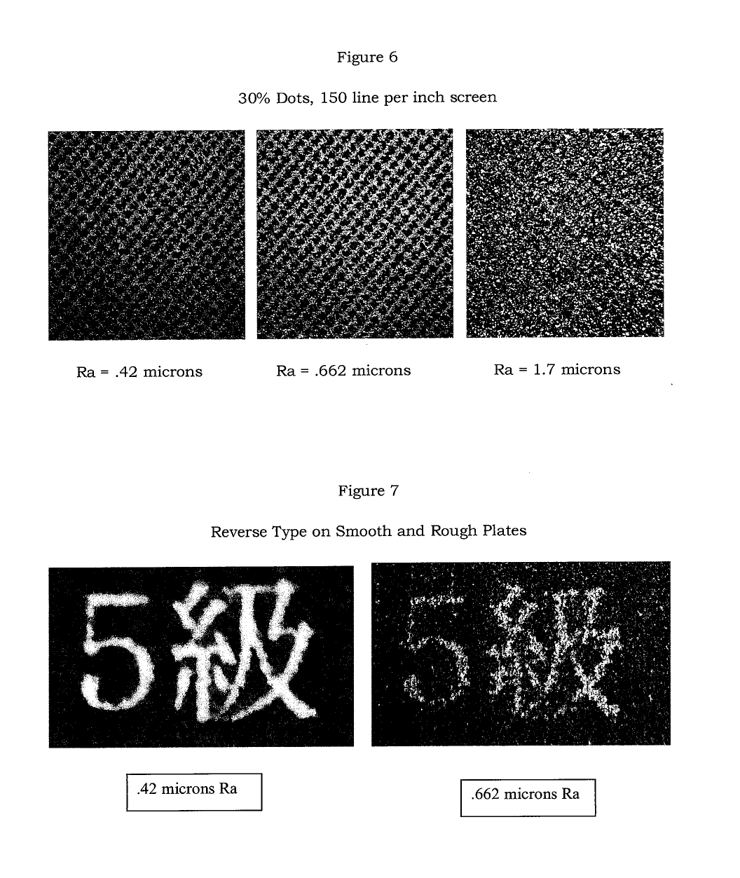

The largest and most visible white dots are seen with the 0.442 micron roughness plate. (Plate roughness measurements were made on plates overcoated with receiver polymer, as described below, using the arithmetic average of absolute values, as is well known to those skilled in the art.) The 0.662 micron roughness plate shows fewer and smaller white dots, and the 1.7 micron roughness plate shows no discernible white dot pattern at all. FIG. 6 shows similar photomicrographs of the same three plates with 30% dots. The improvement in dot quality is obvious with the smoother plates. However, in the case of 30% dots, a faint pattern of dots can be discerned with the roughest (1.7 micron) plate. The quality improvement with smoother plate surface appears to be more important with small white dots than with small black dots. Surprisingly, we can find no reference in the literature related to this effect. We speculate that this effect has not been noticed before because experimental plates are commonly evaluated with small black or colored dots in research laboratories.

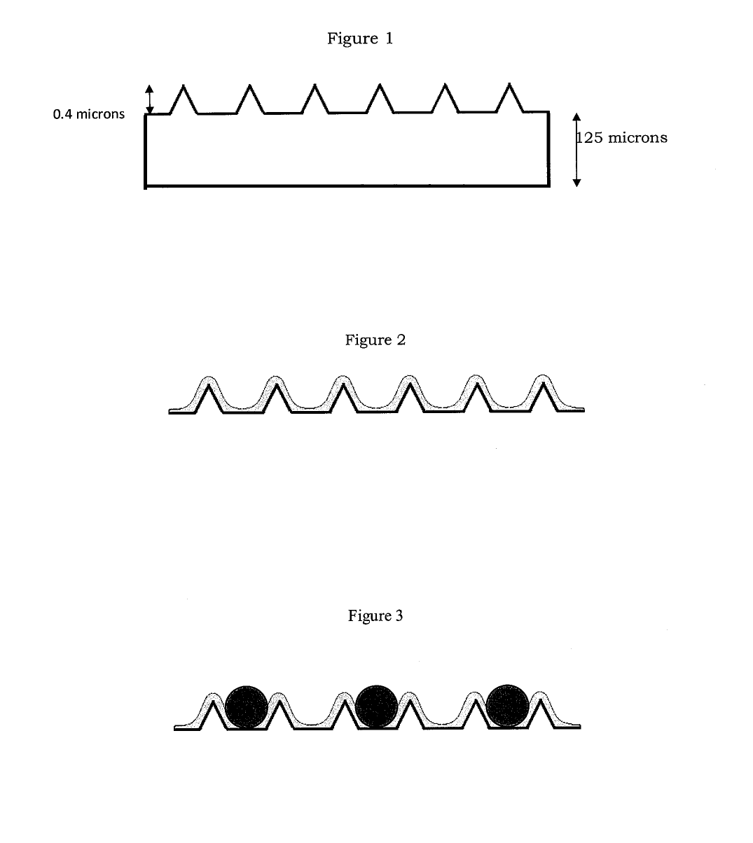

The majority of printing press jobs contain some form of letters of various sizes and fonts. One aspect of image quality that is objective and independent of the scene is the accurate rendition of small letters, and in particular, small white letters on a dark background, also known as “reverse type” by those skilled in the art of printing. For these kinds of letters, on a printing plate prepared by inkjet printing, the inkjet droplets must be located very near each other, but without coalescing to fill in the gap between them, which coalescence would obliterate the white letters. In this application, improved reverse type is provided by the use of a grained anodized aluminum support of a smoothness range from 0.2 to 0.4 microns as measured by the arithmetic average of absolute values. FIG. 1 shows a stylized representation of such an aluminum oxide surface on a 0.005 inch thick (about 125 microns) aluminum plate with a grained anodized surface of about 0.4 microns surface roughness.

The improvement in the appearance of reverse type with smoother aluminum supports is surprising. U.S. Pat. No. 7,014,897 by David Pan suggests that a rougher surface prevents droplet coalescence and gives sharper images. However, Pan uses a wax based hot melt inkjet fluid, which may have quite different properties than the water based inkjet fluid used in the present application. While we do not completely understand the mechanism of the improvement observed in this application, we suggest that a rougher surface on the aluminum support may provide channels for the leading edge of the droplet to coalesce with adjacent droplets.

FIG. 7 shows photomicrographs of small reverse type in both Roman and Kanji characters. The legibility and openness of the characters on the smoother plate is obvious.

The grained anodized aluminum surface of this embodiment is overcoated with an aqueous solution of a film forming polymer and at least one surfactant. When dry the overcoat is continuous, that is, there is no bare aluminum anywhere on the plate. For the purpose of this application, an “aqueous solution” is defined as having two properties—1) a 2% by weight mixture of the polymer in water that will not separate into layers upon standing, and 2) a 2mm thick layer of a 2% by weight mixture of the polymer in water will be transparent enough that a newspaper can be read through it. This overcoat will smooth the surface somewhat, as illustrated in FIG. 2. The overcoat has two functions. First, to protect the plate from fingerprints and scuffing that might accept ink on the printing press. (On the press, the overcoat is dissolved and removed by the fountain solution.) The second function is to provide the correct surface energy for the inkjet droplet. A low surface energy will produce a small inkjet droplet that does not spread on the surface of the plate. These inkjet droplets are stylistically illustrated in FIG. 3 as perfect spheres, and are approximately to scale in size. Actual droplets will not have a perfectly spherical shape, but will more nearly approach this shape as the surface energy of the overcoat is lowered. The lower surface energy is achieved by the addition of surfactants to the overcoat. Fluorocarbon surfactants such as Zonyl RP (DuPont Corp.) and Novek 4200 (3M Corp.) are particularly preferred for this purpose.

The film forming polymer in the overcoat may be selected from a wide range of materials commonly used in the printing industry to protect and preserve printing plates before and between use on the press. Examples of these are gum arabic, guar gum, soluble starch and sugars, locust bean gum, hydroxyethyl cellulose, poly vinyl ethyloxazoline, poly vinyl pyrollidone, poly acylamide, and poly vinyl alcohol, all known to those skilled in the art. The choice of which polymers and surfactants to use in the plate coating mixture is dictated by 1) the rate of dissolution of the polymer layer in the fountain solution on the printing press and 2) the surface energy of the dried coating on the aluminum plate. In a preferred embodiment, the coating fluid consists of from about 1% to about 4% polyvinyl alcohol with from about 0.01% to about 0.1% Zonyl FSN (DuPont) fluorocarbon surfactant in water. In the preferred embodiments, the surfactants in the plate overcoat fluid are chosen from commercial surfactants to provide a low enough surface energy so that the printed drops of inkjet fluid do not spread and lower the resolution of the final printing plate.

The overcoat solvent is primarily water, but may also contain alcohols or other water miscible organic solvents to improve spreading and drying properties of the overcoat.

The coating may be applied to the aluminum surface any common coating method. The applied coating is very thin, less than a gram per square meter when dried. A thicker coating slows the bonding of the inkjet image to the aluminum support when heated, requiring long heating times and higher temperatures. If too high a baking temperature is used, the background portions of the plate become ink receptive and the press impressions are unusable.

The coated aluminum plate is then imaged by printing inkjet droplets of a water based fluid that, when dried and heated, has an affinity for lithographic printing ink on the printing press. The inkjet fluid includes a waterborne resin, a colorant, surfactants to control the surface tension of the fluid, and thickeners to control the viscosity of the fluid. The waterborne resin may be in the form of a solution or dispersion or emulsion or any combination of the three. The fluid may additionally include alcohols or other water miscible organic solvents, humectants to retard nozzle clogging when the inkjet printer is not being used, biocides to inhibit bacterial and mold growth, stabilizers to provide stability over time for the fluid, and acids or bases and buffers to control the pH of the fluid. In preferred embodiments, the fluid contains from about 2% to 15% of a polymer comprising one or a plurality of monomers selected from styrene, vinyl acetate, vinyl toluene and acrylic or methacrylic acid esters of alcohols of one to four carbon atoms and a minor amount of acrylic or methacrylic acid. The inkjet fluid also contains volatile basic compounds such as ammonia, the aliphatic amines, ethanol amine, diethanolamine and triethanolamine. These amines solubilize the polymer in the water based inkjet fluid and prevent plugging of the inkjet printing head. The inkjet printing fluid also contains one or more surfactants to control the surface tension to provide the desired droplet size and prevent spreading of the drop on the plate before the droplet dries. The use of such surfactants in inkjet printing fluids is well known to those skilled in the art of inkjet printing. In preferred embodiments the surface tension of the inkjet fluid is between about 20 and about 60 dynes per centimeter, and most preferably between about 40 and about 50 dynes per centimeter. Similarly, the viscosity of the inkjet fluid can be controlled by the addition of thickeners such as polyethyleneglycol to give the best quality images, as is known to those skilled in the art. In a preferred embodiment, the viscosity of the inkjet fluid is between about 3 centipoise to about 5 centipoise. Finally, the inkjet fluid may contain colorants, either dyes and/or pigments, to visualize the printed image for evaluation.

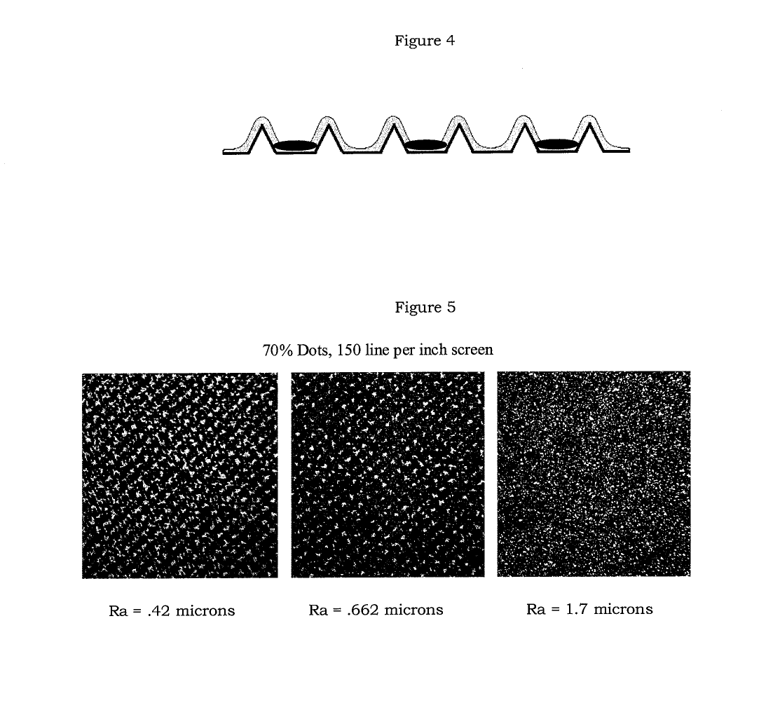

After the image is printed by the inkjet fluid onto the plate, the plate is dried and cured by heating in an oven. The oven heat can be supplied by hot air or by radiant heating such as an infra-red glow bar. The heating bonds the image with the grained aluminum, and increases the oleophilic properties of the image by volatilizing the amines, rendering the polymer insoluble in fountain solution, oleophilic, and stable during the lithographic printing process. The plate after heating is illustrated in FIG. 4. In preferred embodiments of this application, we have found that surface pH of the grained anodized aluminum support affects the bonding of the image to the aluminum support; a surface pH between 9 and 11 gives better bonding than a pH of 3 to 5.

There are several elements in an optimized printing plate. In the most preferred embodiment of this application the most important element is the roughness of the grained anodized aluminum substrate. As FIGS. 5 and 6 show, when the plate roughness is 1.7 microns Ra, even with the best overcoat and optimum inkjet printing fluid, the quality of the printing is too poor to be salable. When smooth plate substrates are used, about 0.4 microns Ra, other elements become important.

Thus, for a given substrate smoothness, the thickness and the surface energy of the overcoat must be controlled. If the overcoat is too thick, the bonding of the inkjet fluid dots to the printing plate may be weakened, and the printing press run length shortened. The chemical composition of the overcoat polymer should be selected to provide good bonding of the inkjet dots during the heat curing step. In principle, this means the overcoat polymer should be rapidly soluble in the inkjet fluid when heated. However, the actual choice of polymer and the overcoat thickness is based on the trial and error method, that is, by testing a variety of polymer overcoats and coating thicknesses and selecting the one that performs best.

The surfactant chosen for the overcoat (again by trial and error) primarily determines the surface energy of the overcoat. This surface energy should be as low as possible to prevent spreading of small droplets of inkjet fluid.

### EXAMPLES

### Example 1

An electrochemically grained and anodized aluminum plate, 0.005 inches thick, with a silicated surface was obtained from the Panart Corporation. The plate was overcoated with the following mixture by means of two soft silicon rollers.
1000 ml water
20 ml Dowanol (an alcohol from the Dow Chemical Company)
20 ml DMP 2281 (a primer from the Reinol Company of Torino, Italy)
4 ml Dowfax (a surfactant from the Dow Chemical Company)
8 drops of Zonyl RP (a surfactant from the DuPont Chemical Company)

After coating, the plate was dried in an hot air oven for 30 seconds. The overcoated plate had a surface roughness of 0.622 microns (as measured by the a.m. method).

### Example 2

The plate of example 1 was imaged on an Epson inkjet printer with the following inkjet fluid:
1. 450 g water
2. 80 g of Neoryl AR-301 polymer emulsion from the Hap Dong Polymer Company
3. 8 ml of concentrated ammonia (35%)
4. 2 g Surfynol SE from Air Products Corporation
5. 40 g Triethanolamine
6. 5 g Brilliant Blue R dye (CI 42660)

After the inkjet image was printed, the plate was dried by heating the plate precursor to a temperature of 180 degrees C. for five minutes. The smallest dots on the plate were measured to be 20 to 22 microns in diameter.

### Example 3

The printing plate of example 2 was mounted on a Ryobi printing press and several hundred high quality impressions were printed.

### Example 4

A grained anodized aluminum plate was obtained from the Southern Lithoplate Corporation. It was overcoated with the mixture of Example 1 and printed with the inkjet fluid of example 2. The overcoated plate had a surface roughness of 0.42 microns Ra. After curing at 180 degrees C. for five minutes, the plate was mounted on the press and several thousand high quality impressions were made. Photomicrographs of dark tints show improved quality compared to Example 3.

Comparative Example 5—a plate with no overcoat.

The inkjet fluid of example 2 was loading into an Epson inkjet printer and an image printed on a bare grained anodized aluminum printing plate substrate. The image was dried with a hand held hot air dryer. The smallest dots on the plate were approximately 100 microns in size. The dots were difficult to measure accurately because the edges of the dots were not sharply defined. The dried printing plate was mounted on a Ryobi printing press and used to print 100 impressions. The printed images were too low in resolution to be sold. The 3 point reverse type was completely filled in and illegible.

Comparative Example 6—a rough plate with overcoat.

A mechanically grained anodized aluminum printing plate substrate with a roughness value greater than 1.7 microns was overcoated as in Example 1. The coated plate was printed with an inkjet image as in Example 2. After drying, the spread of the image dots was so large as to render the plate useless for printing saleable impressions. The diffuse edges of the smallest dots were difficult to accurately measure, but the smallest dots were about 100 microns in size.

### Example 7

A grained anodized aluminum printing plate substrate of 0.42 microns roughness was wiped with a cotton pad soaked in a mixture of:
85 ml water
12 g polyethyloxazoline
100 microliters Zonyl FSN surfactant
3 g di(sodiumsulphonate)diphenyloxide
Sodium hydroxide to a pH=11.5
   The plate prepared above was dried with a hand held hot air dryer. The plate was then imaged with the inkjet fluid disclosed above. The plate produced a high quality image on the Ryobi press.

Many alterations and modifications may be made by those having ordinary skill in the art without departing from the spirit and scope of the embodiment. Therefore, it must be understood that the illustrated embodiment has been set forth only for the purposes of example and that it should not be taken as limiting the embodiment.

What is claimed is:

1. An inkjet imageable lithographic printing plate precursor comprising:
a grained anodized aluminum support having a continuous overcoat of at least one water-soluble polymer with at least one surfactant to provide a surface energy producing a contact angle greater than 100 degrees with a sessile drop of water and the overcoated surface is smoother than about 1 micron as measured by the arithmetic average of absolute values.

2. The printing plate precursor of claim 1 wherein the continuous overcoat dry weight is less than about 2 grams per square meter.

3. The printing plate precursor of claim 1 wherein the continuous overcoat dry weight is less than about 1 gram per square meter.

4. The printing plate precursor of claim 1 wherein the water soluble polymer is polyvinylpyrrolidone or polyvinylalcohol or a mixture of polyvinylpyrrolidone and polyvinylalcohol.

5. The printing plate precursor of claim 1 wherein the surfactant comprises a fluorinated hydrocarbon.

6. An inkjet imageable lithographic printing plate precursor having superior press performance with small reverse type comprising:
a grained anodized aluminum support having a continuous overcoat of a water-soluble polymer with a surfactant to provide a surface energy low enough to produce a contact angle greater than 100 degrees with a sessile drop of water and the overcoated surface is smoother than about 0.4 microns as measured by the arithmetic average of absolute values.

7. The printing plate precursor of claim 6 wherein the continuous overcoat dry weight is less than about 2 grams per square meter.

8. The printing plate precursor of claim 6 wherein the continuous overcoat dry weight is less than about 1 gram per square meter.

9. The printing plate of claim 1 adapted to be imaged by a waterborne resin ink containing from about 2% to about 15% of a polymer of at least 50,000 daltons molecular weight.

10. The printing plate of claim 7 adapted to be imaged by a waterborne resin ink containing from about 2% to about 15% of a polymer of at least 50,000 daltons molecular weight.

11. The printing plate precursor of claim 6 wherein the water soluble polymer is polyvinylpyrrolidone or polyvinylalcohol or a mixture of polyvinylpyrrolidone and polyvinylalcohol.

12. The printing plate precursor of claim 6 wherein the surfactant comprises a fluorinated hydrocarbon.
